(19) United States
(12) Patent Application Publication
(10) Pub. No.: US 2003/0132880 A1
(43) Pub. Date: Jul. 17, 2003

(54) Precision position measurement system

(76) Inventor: Kenneth James Hintz, Fairfax Station, VA (US)

Correspondence Address: Kenneth J. Hintz, 11727 Lakewood Lane, Fairfax Station, VA, 22039, US

(21) Appl. No.: 10/046,360

(22) Filed: Jan. 14, 2002

(51) Int. Cl. G01S 3/02

(52) U.S. Cl. 342/442; 342/465

(57) ABSTRACT

The Precision Position Measurement System (PPMS) measures the location of the source of electromagnetic radiation in 3-D physical space to accuracies on the order of fractions of a wavelength using phase difference measurements among several receiving antennas, one of which is designated as the reference. All signal processing is done at the transmitter's RF frequency and in a single receiver with distributed RF signal amplification. Spatially distributed RF amplification is used to achieve sufficient signal strength for phase measurement without using up/down conversion receivers thereby eliminating sources of error due to local oscillator instability.

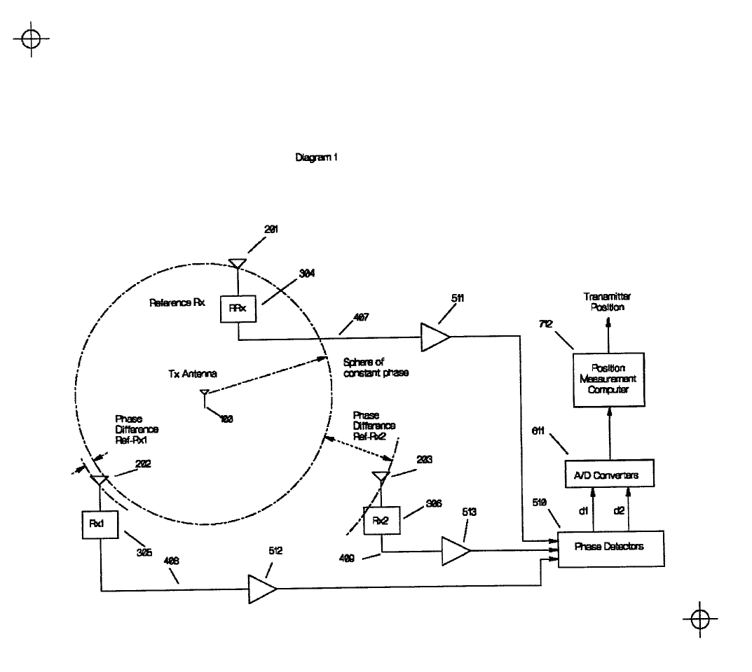

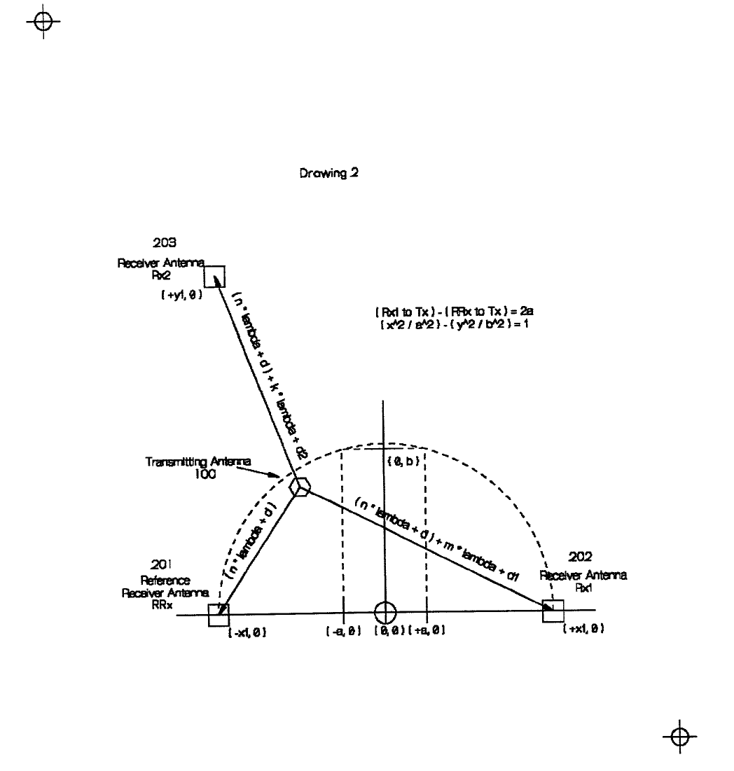

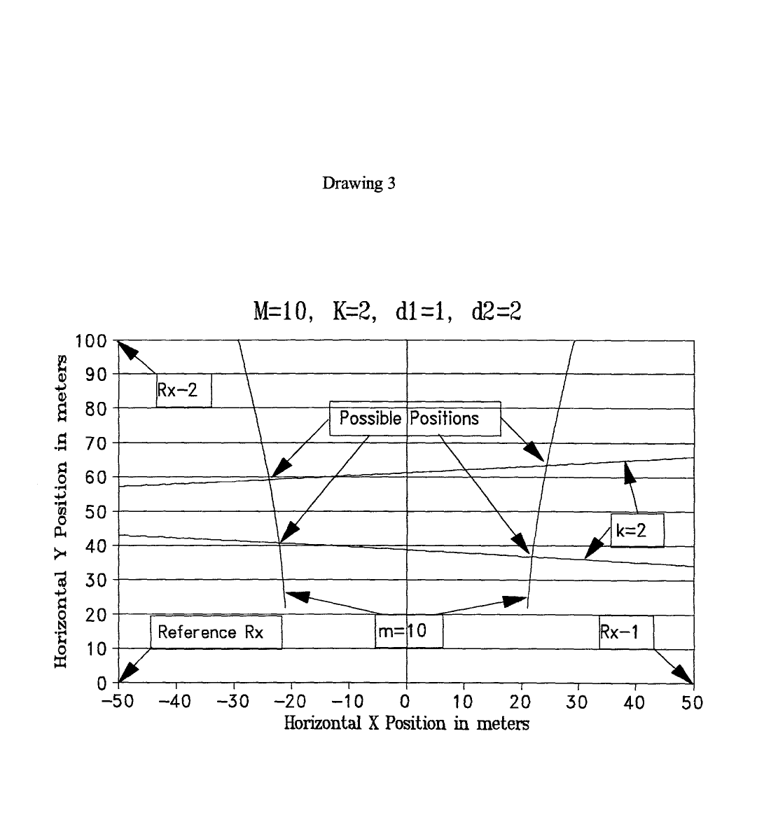

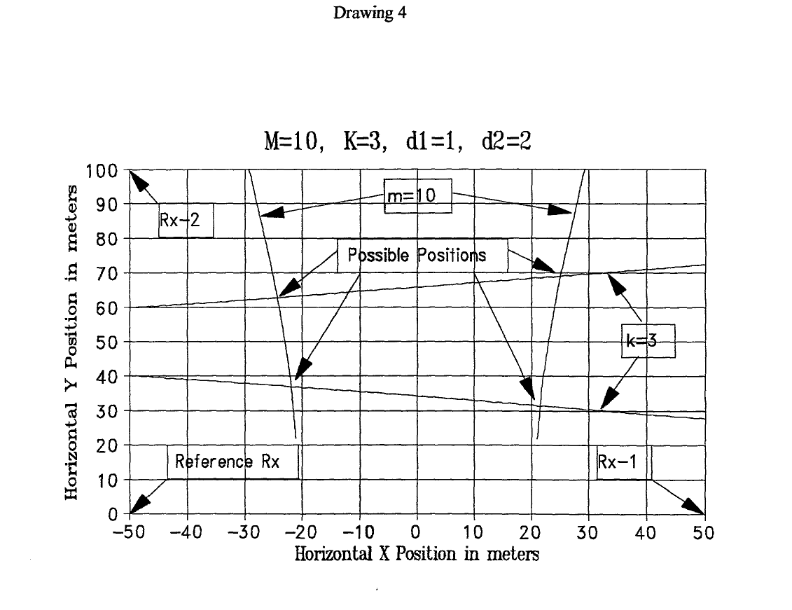

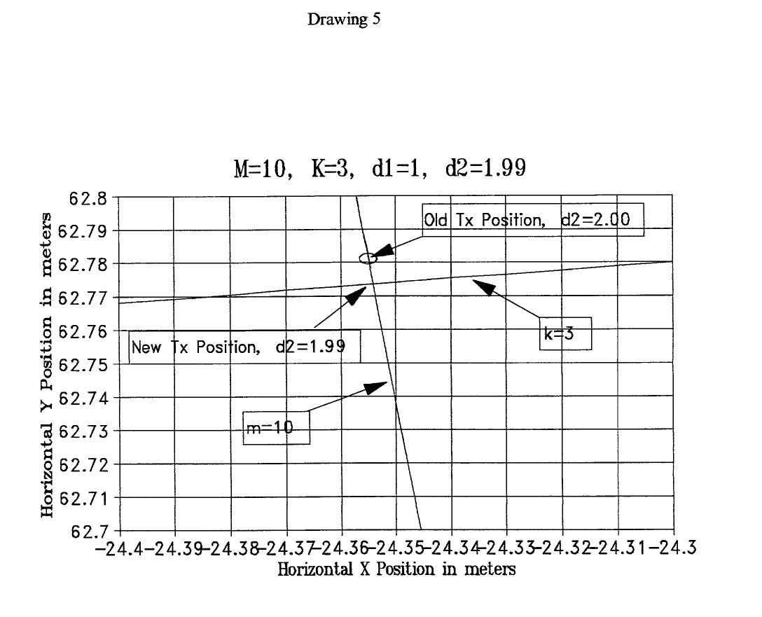

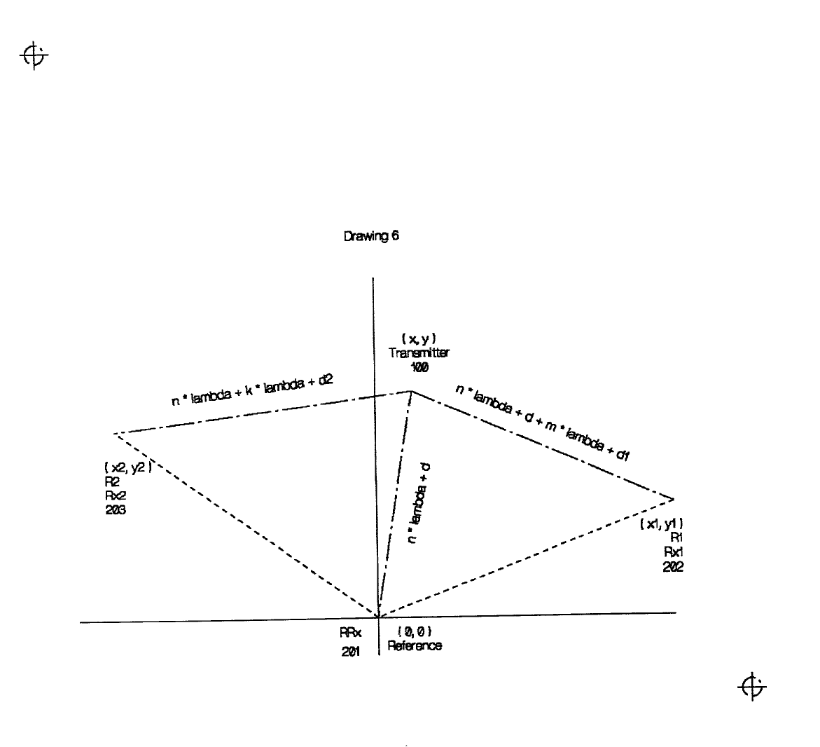

### CROSS-REFERENCE TO RELATED APPLICATION

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM

Not Applicable.

### BACKGROUND OF INVENTION

The field of endeavor to which this invention pertains is primarily Class 342 (Communications: Directive Radio Wave Systems and Devices) and can be further classified in:

subclass 21 (Base Band System),

subclass 127 (Determining Distance, Phase Comparison),

subclass 437 (Directive, Beacon or receiver, Direction-finding Receiver only, With plural fixed antenna pattern comparing, including more than two antennas),

subclass 451 (Directive, position indicating, by computer), or

subclass 457 (Directive, position indicating, land vehicle location).

There exists a need to accurately measure the position of objects and track their movement in a real-world, real-time environment. Examples of this need range from measuring the state of highly maneuvering, autonomous vehicles to tracking wildlife for basic scientific research as well as clandestine tracking of unintended electromagnetic emissions. Additional applications of this technique include:

biological feedback to virtual reality systems by measuring the positions of the extremities of the human moving through the virtual space,

tracking multiple interacting autonomous vehicles,

operator input for telerobotics, and,

measuring the position of and tracking actors on stage.

Existing systems for performing precision position measurements are generally expensive (optical, radar), susceptible to interference (wide bandwidth time-difference-of-arrival), require narrow field of view sensors which must themselves move or beam-steer to track the object (optical/radio frequency), are of limited range (magnetic, electrostatic), and/or require high-power transmitters (radar, sonar). The advantages of this new system are several, including:

the receiving antennas have no unusual requirements except for spatial diversity,

the receiving antennas can be fixed or moving with their position known,

the bandwidth of the receivers is extremely narrow and only determined by the speed of movement of the transmitter being tracked,

the accuracy of the position measurement is determined by the geometry of the receiving antennas, the carrier frequency of the transmitted signal, and the ability to resolve the phase differences in the received signals, and,

multiple objects can be measured simultaneously through frequency or time division multiplexing

It is well-known that the position of a continuous wave (CW) transmitter can be tracked to an accuracy determined by the stability of its carrier frequency generating oscillator and the signal receivers' local oscillators while at the same time using a very narrow receiver bandwidth. This can be done by measuring the cycle-by-cycle change of the carrier phase with reference to receivers with extremely stable local oscillators which yield relative range changes of fractions of a wavelength radially from each of the receiving antennas. The intersection of these multiple radii fix the position of the transmitter. If the initial position of the vehicle is not precisely known, an approximate position of the transmitter can be used to begin the tracking process with the absolute position being refined as more and more measurements are taken. If the initial vehicle position is precisely known, then an absolute track can be maintained from track initiation through a sequence of measurements. If it is not known, then an approximate position can be used for initialization and subsequent measurement used to refine the position.

The drawback of this approach is that the position accuracy is determined by the stability of all of the oscillators involved, not just the transmitting oscillator's stability. For example, normal radio frequency (RF) receivers utilize several stages of up/down conversion in order to improve signal/noise ratios, take advantage of the different noise properties of electronics at different frequencies, and provide enough signal amplification for the signal detection process to occur. In fact, at all but the shortest ranges, several stages of amplification of a received RF signal are required in order to generate a signal with sufficient amplitude to activate an electronic detector. Typical minimum signal strength for mixing is +7 dBm. Because of the spatial diversity of the receiving antennas which is required in order to achieve a sufficient baseline for accurate position measurements, either extremely stable oscillators at each receiver are required (e.g., atomic frequency standards), or a means of synchronizing all the oscillators among the various receivers and the transmitter.

Several patents have been found in a search of issued patents which appear to be similar to the invention disclosed herein. For simplicity, the patent disclosed herein will be referred to as the PPMS system. Each of the relevant patents is briefly reviewed in the following to point out the differences between its claims and those of the disclosed PPMS system.

3,419,865, Chisholm: This is a time-difference of arrival (TDOA) system whose accuracy is determined by the bandwidth of the receivers. PPMS can locate transmitters with greater accuracy than TDOA using narrow band receivers. PPMS also does not require synchronized transmitters.

4,028,703, Honore, et al.: From the description through column eight and the drawing on the first page, it appears that multiple, fixed location transmitters operating on different frequencies are used. The PPMS system requires only a single frequency signal to be transmitted from the platform being tracked.

4,659,982, Van de Velde, et al.: This invention measures the position of a body by irradiating it with a signal whose spectrum is changed by its interaction with the body to be tracked. This spectral modification is analyzed to determine position. PPMS does not radiate a signal but measures an intentional or unintentional radiation from a body. PPMS' performance is not predicated on changes in the spectrum of a signal due to the signal's interaction with the body.

4,680,590, Lowe et al.: This is an Omega system which utilizes the transmission of multiple synchronized signals from known sites and the reception of the multiplicity of these signals on a body in order to determine its position. The phase measurements referred to in this invention are the phase of the pulse which is transmitted from the multiple sites, not the carrier which is modulated to create the pulse. PPMS does not use multiple transmitters. PPMS does not need the wide bandwidth receivers and its accuracy is determined by the RF carrier's wavelength.

4,675,684, Spence: This is a distance-measuring-only receiver and the claims show it to be based on the transmission of two signals from the platform being tracked. The PPMS system measures 3-dimensional position as well as requires only a single frequency signal to be transmitted from the platform being tracked.

4,680,590, Lowe, et al.: The claims of this patent require multiple signals to be transmitted from fixed sites in addition to there being a fixed receiving site for measurement and computation of the correction. This is in addition to a receiver on the platform whose position it is desired to know. The PPMS system requires only a single CW signal transmitted from the platform being tracked.

5,023,809, Spackman et al.: All of the claims mention a “means for translating whereby the transmitted radio signal is received and retransmitted to a base receiving station.” The PPMS system does not do any “translating.” The unmodulated carrier signal is amplified and conveyed without frequency translation through coaxial cable (or alternately fiber optic waveguide if the transmitted electromagnetic energy were of high enough frequency) to a central phase detector/processor for determination of the phase differences and computation of the emitter's position.

5,045,861, Duffett-Smith: The claims present a system which requires at least “ . . . one transmission source . . . equal in number at least to the number of dimensions in which the movement . . . is to be monitored.” Additionally, the description of the device shows that a very wide-band receiver is required. The PPMS system requires only a single frequency signal to be transmitted from the platform being tracked independent of the number of dimensions it is being tracked in. It does, however, require at least one more fixed receiving antenna than the number of dimensions in which the transmitter is to be tracked. The PPMS system requires only very narrow bandwidth receivers, the bandwidth being determined by the velocity of the emitter relative to the fixed receiving antennas.

5,144,315, Schwab et al.: The claims require identification friend or foe (IFF) transmission from all of the platforms being tracked as well as specific modulation. Furthermore, wide-band receivers are required The PPMS system does not require complex IFF transmitters nor does it require modulation or wide-band receivers.

5,150,310, Greenspun et al.: The claims can be divided into two basic types of systems. The first uses a modulated signal which requires a wide-band receiver. The second uses a transmitter which transmits a “strobe.” The PPMS system does not require modulated signals nor does it require a wide-bandwidth receiver to process a strobe signal.

5,173,710, Kelley et al.: The claims of this invention require multiple, fixed location, unsynchronized transmitters as well as a fixed receiving site for error computation. The PPMS system does not require multiple transmitted signals.

### BRIEF SUMMARY OF INVENTION

The objective of this invention is to track the position of a moving body which radiates electromagnetic energy. While this is its specific purpose, it can more generally be applied to determining the position of a source of electromagnetic radiation relative to a set of receiving antennas or conversely it can be applied to determining the position of a set of receiving antennas relative to one or more fixed radiators. A further extension of this principle is that if multiple, spatially separated radiators of known position are measured, the position and orientation of the frame of reference of the radiators or the frame of reference of the receiving antennas can be determined.

The general idea of the claimed PPMS invention is to accurately measure the location of an emitter of electromagnetic radiation in 3-dimensional space by measuring the phase difference among the electromagnetic radiation received at several antennas without frequency conversion. This is accomplished by designating one of the receiving antennas as a reference and measuring the phase difference between the received electromagnetic signal at each of the several antennas and the reference. The novelty of this invention is that the amplification of this received signal is spatially distributed along the cables interconnecting the antennas so as to effectively decouple the receiving antenna from the amplified signal in order to prevent oscillations in the receiver. As was mentioned in the BACKGROUND OF THE INVENTION, at all but the shortest ranges, several stages of amplification of a received RF signal are required in order to generate a signal with sufficient amplitude to activate an electronic detector such as a diode mixer.

Typical minimum signal strength for mixing is +7 dBm and typical received signal strength is on the order of −60 to −110 dBm at the receiving antenna. The difference between the required mixer level and the received signal level must be compensated for by RF amplifiers of typically 50 to 120 dB gain. Typically, at amplifier gains of greater than 30 dB, the output signal is sufficiently strong so as to couple back into the input to cause oscillation and make the amplifier ineffective. Since the cable loss is much less than the free-space propagation losses, amplifiers can be distributed at various distances along the cable which connects the antennas to the receiver to amplify the signal to the required mixer level without creating a feedback signal of sufficient strength to result in oscillations. The free-space losses from the leakage output of the second and subsequent amplifiers back to the receiving antenna are large enough to decouple the antenna from the signal which is sufficiently amplified to allow for mixing with the other antennas' received signals.

Multiple conversion receivers cannot be used in this process because of the non-deterministic phase errors which are introduced by local oscillators which are not phase-locked to the transmitter's frequency. This phase-locking cannot be achieved since the transmitter is moving and introducing phase errors which is what one is trying to measure. It is not sufficient to frequency lock the local oscillators (LO) to the transmitting frequency since this still introduces a phase uncertainty into the system which cannot be corrected.

It is well known that phase differences between received signals can be used to generate hyperbolic lines of position (LOP). Phase differences among multiple receiving antennas can be used to generate multiple LOPs whose intersection will “fix” the location of an emitter to integer cycles of phase difference. There are several methods which can be used to resolve this integer ambiguity:

repeated measurements of the emitter as it moves,

an over-determined array of antennas,

known starting or ending position of a moving emitter, or,

movement of the receiving antenna array whose position is known.

The differences detailed in the BACKGROUND of the INVENTION between the PPMS system and the similar patents are notably brief and focus only on the major differences. In general, it can be said that the PPMS system has the following advantages over the patents listed above:

PPMS is overall much simpler than any others in that it requires only a simple, continuous-wave (CW) transmitted signal from the body whose position it is desired to measure;

PPMS does not require frequency translation or wide-bandwidth receivers which are both complex and expensive;

PPMS does not require a separate receiving site to compute error functions which are then transmitted to the other receivers;

There is only a single “receiver” which is actually multiple phase detectors followed by A/D conversion and a computer.

PPMS does not require continuous reception of the transmitted signal by any or all antennas provided that the duration of the interruption is sufficiently short relative to the distance the emitter has moved. This can be compensated for, in any event, by multiple redundant receiving antennas. Remember that the additional cost is an antenna, amplifiers, interconnecting cable, and a phase detector which is much less expensive than an additional receiver;

The only equipment which must be carried by the platform to be tracked is a small, lightweight, inexpensive, CW transmitter. This is particularly of value when the platform to be tracked is disposable or not capable of carrying a large payload. In general, all of these other systems have been developed for relatively long range position measurement applications and for platforms for which weight and space is not a premium The PPMS system is primarily a relatively short range, high accuracy, and inexpensive, position measurement system.

The PPMS system requires no modulated signal and therefore it has many uses in covert tracking of non-cooperative moving transmitters. It can work with modulated signals.

Position measurement accuracies are on the order of fractions of a wavelength.

Orientation of a vehicle carrying multiple CW transmitters/antennas on different frequencies can be determined by accurately measuring the position of each transmitter thereby giving a 6 degree of freedom (6-DOF) measurement of the kinematic state of a vehicle or other object.

In an inverse application of the principle, multiple receiving antennas on a body can be used to determine the body's line of position and orientation relative to the known position of a radiator. Utilizing 3 transmitted signals all 6 degrees of freedom of the moving body can be measured.

Receiving antennas need not be directional but only have enough gain to maintain a usable signal-to-noise ratio (SNR).

### BRIEF DESCRIPTION OF THE SEVERAL VIEWS OF THE DRAWING

Drawing 1 shows a block diagram of the relationship and interconnection among the means for implementing the PPMS system including the several antennas, amplifiers, cables, spatially distributed amplifiers, phase detectors, and computational device.

Drawing 2 defines for a specific 2-dimensional case the mathematical relationship among the various parameters, signals, and different pathlengths as a function of the number of wavelenths of the transmitted signal.

Drawing 3 shows the set of possible positions at which the transmitter could be given M=10, K=2, d1=1, and d2=2. These parameters are defined in Drawing 2.

Drawing 4 shows the set of possible positions at which the transmitter could be given M=10, K=3, d1=1, and d2=2. These parameters are defined in Drawing 2.

Drawing 5 shows the change in emitter position which would be computed from measuring no phase change in d1 from Drawing 4 and a change in d2 from 2.0 in Drawing 4 to 1.99.

Drawing 6 shows or the general 2-dimensional case the mathematical relationship among the various parameters, signals, and the different pathlengths as a function of the number of wavelenths of the transmitted signal.

### DETAILED DESCRIPTION OF THE INVENTION

The following is a detailed description of the method and apparatus for implementing the PPMS system. With reference to Drawing 1, the position of a transmitting antenna radiating an RF signal can be tracked to an accuracy determined by the frequency of its unmodulated signal and to a lesser extent, the stability of the transmitter's frequency-generating oscillator. This can be done with a very narrow receiver bandwidth and fixed antennas. The method for doing this is to measure the cycle-by-cycle change of the transmitted signal's phase (or fraction thereof) of each of the signals received by several, spatially diverse antennas with reference to one of the received signals which is arbitrarily designated the reference signal. These relative phase measurements yield differential line-of-position (LOP) changes in the measured position of the transmitter. The intersection of these multiple hyperbolic LOPs of constant phase can be used to fix the position of the transmitter is physical space. Differential changes in these LOPs can track the transmitter's movements and thereby maintain a constant measurement of its position.

The process can be thought of as being similar to inverse LORAN with the significant differences being that LORAN requires wide bandwidth receivers since the LOPs are determined from differential time measurements between the leading edges of pulses from the LORAN transmitters, and that LORAN is a time difference of arrival (TDOA) system rather than a modulated or unmodulated carrier phase measurement system. The PPMS system only requires enough receiver bandwidth to compensate for Doppler shift induced by the relative motion of the receiving antennas and the radiating antenna. This Doppler shift is extremely small.

The following is a detailed description of an implementation of a nominal 2-dimensional (2D) Precision Position Measurement System (PPMS) which will be used to exemplify the actual reduction to practice which was implemented at an RF frequency of 440 MHz. This method can be easily extended to 3-dimensions (3D) by one skilled in the art by straightforward extensions of the principles described in the following. It can be further extended to measuring orientation as well as position by measuring the position of multiple radiators which are spatially separated in a known frame-of-reference.

Drawing 1 shows the basic means needed for the PPMS system. 100 is a means for radiating electromagnetic energy. In this drawing, 100 is the transmitter with transmitting antenna whose position is to be measured. This transmitter and transmitting antenna may be an actual antenna intended to radiate or a leakage signal from a device which is not intended to transmit a signal but which does. In general, this will be referred to as an emitter, transmitter, transmitting antenna, radiator, or any of several common terms describing the source of radiation of electromagnetic energy.

In Drawing 1, 201, 202, and 203 are the means for receiving the electromagnetic energy radiated by 100 whose locations are known. In this drawing, they are antennas which receive the signal which is radiated by 100. 201 is the arbitrarily chosen reference receiver (RRx). 202 is a second receiving antenna. 203 is a third receiving antenna. Three is the minimum number of receiving antenna for a 2-D system; additional antennas can be used and provide the redundancy which can be used to resolve the multiple cycle ambiguity. The minimum number of receiving antennas for a 3-D system is four.

304, 305, and 306 are means for reducing the bandwidth of the received signal to isolate the desired signal from other signals if this is required. 304, 305, and 306 are the first stage of received signal amplification for each receiving antenna. In this drawing, these means are narrow bandpass filters and first RF amplifiers. No frequency conversion takes place in these amplifiers or anywhere in the system. The electromagnetic energy received from the transmitting means 100, by antennas 201, 202, and 203 is increased in amplitude to enable further signal processing. The gains of these first RF amplifiers 305, 306, and 307, are limited in their input/output isolation by practical construction practices to approximately 30 dB. If the gain of the amplifier is more than the input/output isolation, the amplifier may oscillate rather than amplify the received signal.

407, 408, and 409 are interconnecting means which convey the output signals from first RF amplifiers 305, 306, 307 to the second RF amplifiers 511, 512, and 513 without loss of phase information. 407, 408, and 409 are, in this case, coaxial cable. These second RF amplifiers 511, 512, and 513 provide additional RF amplification to the received signals and are located at a sufficient physical distance from the receiving antenna to prevent leakage signals of sufficient amplitude to reach the receiving antennas which could induce oscillations. These second amplifiers provide additional signal amplification which may be required to increase the amplitude of the signals produced by the first RF amplifiers 304, 305, and 306 to a level such that they can be mixed to obtain phase differences. Due to the narrow bandpass of the first RF amplifiers 305, 306, 307, the second RF amplifiers 511, 512, and 513, can be broadband amplifiers. The second amplifiers are spatially dispersed from the receiving antennas such that their additional amplification does not leak a signal strong enough to be received by the receiving antennas 201, 202, and 203, and turn the system into an oscillator. That is, it is the combination of the electronic input/output isolation within each of the amplifiers and the spatial input/output isolation provided by the distributed amplification which allows the system to work at the transmitter's RF frequency without frequency conversion and the local oscillators which would otherwise be required. Additional stages of distributed amplification may be required to bring the received signals to a sufficient level for mixing.

Drawing 1 also shows a means for measuring the phase difference between the arbitrarily chosen reference received signal from the reference receiver (RRx) 304, and each of the other received signals. The outputs of the second (or higher) amplifiers are connected to mixers contained in the phase detectors 510.

The outputs of the phase detectors 510 are then digitized by the A/D converters 611 and then input into a Position Measurement Computer 712.

Drawing 2 shows a nominal 2-dimensional operating area of 100 meters by 100 meters (25 wavelengths square at 75 MHz) with receivers at three of the corners. Without loss of generality, assume that the difference in phase between the signal received at the reference receiver (RRx) antenna 201 and the receiver antenna (Rx1) 202 is labeled Δ₁ (d1 in the Drawing 1) is λ/4 (1 meter) and that the RF carrier is 75 MHz (4 meters wavelength). Assume also that the difference in phase between the signal received at the reference receiver (RRx) antenna 201 and the receiver antenna (Rx2) 203 is labeled Δ₂ (d2 in Drawing 1) is λ/2 (2 meters). For this to be true, there can be at most a finite number of places where the transmitter can be located. Four such positions are shown in Drawing 3 for the case where m=10 and k=2. There are multiple positions where the transmitter can be since there is an m-wavelength ambiguity from Rx1 to the reference receiver and a k-wavelength ambiguity from Rx2 to the reference receiver. The fact that the Tx is n-wavelengths plus a fixed phase error of d is eliminated in the mathematics. The fixed phase error, d, is due to the unknown cable lengths and amounts to a bias error which mathematically falls out and does not need to be known. Another possible position is shown in Drawing 4 for the case where m=10 and k=3. To resolve this ambiguity there are three possibilities:

Place the object to be tracked at a known starting position,

Measure the object as it moves and then solve for the one possible position which satisfies the constraints of the phase measurements and meets certain physical realizability constraints,

Locate the object accurately at the termination of the tracking of the object and retroactively compute its absolute position from stored measurements, or,

Overdetermine the solution by utilizing more than the minimum number of antennas.

Different object tracking requirements may require the application of any of these alternatives. The details of these calculations and practical implementation are not given here since these techniques are well known by one skilled in the art and their description would add nothing to the elucidation of the invention. An actual reduction to practice has been constructed using the first method and operates successfully at 440 MHz by demonstrating centimeter accuracy.

Since the differential phase represents differential path lengths between the reference antenna and the receiving antennas, the line of position (LOP) of the object is a hyperbola for each pair of receiving antennas. Because of the multiple wavelength modulo nature of the measurements, integers are introduced in the following equations as shown in Drawing 2 to represent these known and unknown quantities. The two equations, which can be solved simultaneously to find the finite set of possible positions are as follows. Any of a number of methods for finding the simultaneous solutions to these LOP equations are well known to one skilled in the art and therefore will not be detailed here. A Newton's approximation method has been successfully implemented in the demonstration system at 440 MHz. The LOP from the reference to Rx1, is described by

$$\begin{matrix}\frac{{x}^{2}}{{[ \frac{m * λ + {Δ}_{1}}{2} ]}^{2}} - \frac{{y}^{2}}{[ \frac{4 {x}_{1}^{2} - {( m * λ + {Δ}_{1} )}^{2}}{4} ]} = 1 \\ \frac{{[ \frac{{y}_{1} - 2 y}{2} ]}^{2}}{{[ \frac{k * λ + {Δ}_{2}}{2} ]}^{2}} - \frac{{( x + {x}_{1} )}^{2}}{[ \frac{{y}_{1}^{2} - {( k * λ + {Δ}_{2} )}^{2}}{4} ]} = 1\end{matrix}$$

Where:

m: the integer number of wavelengths longer the path is from the emitter 100 to Rx1 202 than the path from the emitter 100 to the reference receiver antenna 201 RRx

λ: the wavelength of the transmitted signal in meters

x₁: ½ the distance from the reference RRx 201 to Rx1 202

y₁: the distance from the reference RRx 201 to Rx2 203

k: the integer number of wavelengths longer the path is from the emitter 100 to Rx2 203 than the path from the emitter 100 to the reference receiver antenna 201 RRx

Δ₁: the difference in phase between the signal received by the reference antenna RRx 201 and receiver antenna Rx1 202

Δ₂: the difference in phase between the signal received by the reference antenna RRx 201 and receiver antenna Rx2 203

Assuming that the initial position is known, then m and k are known for this example. The PPMS system measures Δ₁ and Δ₂ and uses these values to solve the two hyperbolic equations simultaneously to determine the new position. A graphical demonstration of this is shown in Drawing 5 which is an enlargement and slight modification of Drawing 4 showing a single point of intersection of the two hyperbola. The difference between the “New Tx Position” and the “Old Tx Position” in Drawing 5 is only a phase change of one part in 400 which equates to 1 cm. One degree of phase difference can be easily distinguished between two signals with commonly available components. For example, one phase detector operating at 75 MHz produces 8 milliVolts/degree of phase change which can easily be digitized by a 9 bit A/D converter to the required accuracy.

The fundamental accuracy of this measurement method is independent of the position once it is known since we are tracking RF phase changes before there is a complete cycle change. The accuracy of the differential range (phase) between any antenna and the reference combined with the angle of intersection of the hyperbolas of position (constant phase) determine the accuracy of the position measurement. More than the minimum number of antennas can be used to improve accuracy by increasing the number of hyperbola which must intersect at a point. Additional antennas can also be used to resolve initial position ambiguity since the measurements are modulo one wavelength and there is only one physical position at which the emitter can be when all the phases are as measured.

When the object is stationary, there is no phase change other than that due to instabilities in the emitter's frequency, and the integers m and k are fixed. Since the distance of the object to the receiving antenna is modulo the carrier wavelength, each cycle crossing of the phase differences must be accounted for when the object is moving. This can be easily done by a computer tracking the digitized output of the phase detector since this phase changes at a rate determined by the velocity of the object and the wavelength of the transmitted signal. Alternatively, a very high speed analog-to-digital converter could be used to directly digitize the received signals and perform the computations in software.

When the emitter moves relative to the receiving antennas, the amplitude of the differential phase signal increases or decreases as the transmitted signal comes more in-phase or more out-of-phase with the reference receiver's signal. Again, assume that the object moves radially from one antenna while moving circumferentially at a constant radius from the reference antenna. That is, the zero crossings of the differential phase of the received signals correspond to one wavelength's movement of the object. As the object moves, the output of the receiver is an approximately sinusoidal waveform whose frequency is proportional to the speed of the vehicle due to the Doppler effect. This is approximately 1 kHz at 1GHz and 300 m/sec vehicle velocity or approximately 27 Hz at 75 MHz and 100 mph. While this direct velocity measurement may also be useful, it is not necessary to the operation and only indicates the minimum update rate required of the measurements.

While the system described above documents the implementation of a 2-dimensional system, the method can be easily extended by one skilled in the art to operate in 3 dimensions.

The previous equations were derived with reference to Drawing 2 and predicated on an orthogonal layout of the receiving antennas in order to simplify the mathematical derivation and representation. There is, however, no requirement for the receiving antennas to be in any particular geometric relationship. With reference to Drawing 6, the following generalized equations have been derived for the determination of the coordinates (x, y) of the transmitter 100 using signals received by the reference antenna RRx 201, receiver antenna Rx1 202, and receiver antenna Rx2 203. To simplify the following equations, and without loss of generality, the reference antenna RRx 201 is considered to be the origin of the 2-dimensional space and located at coordinates (0, 0). Receiving antenna Rx1 202 is located at arbitrary position (x₁, y₁). Receiving Antenna Rx2 203 is located at arbitrary position (x₂, y₂). The two hyperbolic lines of position (LOP) which must be solved simultaneously to determine the position of the transmitting antenna Tx 100 are:

x²C₂−xC₃+2xyC₄−yC₅+y²C₆=C₇

x²C₉−xC₁₀+xyC₁₁−yC₁₂+y²C₁₃=C₁₄

where:

Δ₁=d₁ in Drawing 6

Δ₂=d₂ in Drawing 6

$$\begin{matrix}{α}_{1} = ( {x}_{1}^{2} + {y}_{1}^{2} ) {( m λ + {Δ}_{1} )}^{2} \\ {β}_{1} = ( {x}_{1}^{2} + {y}_{1}^{2} ) ( 4 \sqrt{{x}_{1}^{2} + {y}_{1}^{2}} - {( m λ + {Δ}_{1} )}^{2} ) \\ {C}_{1} = \frac{{x}_{1}^{2}}{4} + \frac{{x}_{1}^{2} {y}_{1}^{2}}{2} + \frac{{y}_{1}^{2}}{4} \\ {C}_{2} = {β}_{1} {x}_{1}^{2} - {α}_{1} {y}_{1}^{2} \\ {C}_{3} = {β}_{1} {x}_{1}^{3} + {β}_{1} {x}_{1} {y}_{1}^{2}\end{matrix}$$

C₄=x₁y₁(β₁−α₁)

$$\begin{matrix}{C}_{5} = {β}_{1} {y}_{1}^{3} + {β}_{1} {y}_{1} {x}_{1}^{2} \\ {C}_{6} = {β}_{1} {y}_{1}^{2} - {α}_{1} {x}_{1}^{2}\end{matrix}$$

C₇=β₁(α₁−C₁)

$$\begin{matrix}{C}_{8} = \frac{{x}_{2}^{2}}{4} + \frac{{x}_{2}^{2} {y}_{2}^{2}}{2} + \frac{{y}_{2}^{2}}{4} \\ {α}_{2} = ( {x}_{2}^{2} + {y}_{2}^{2} ) {( k λ + {Δ}_{2} )}^{2} \\ {β}_{2} = ( {x}_{2}^{2} + {y}_{2}^{2} ) ( 4 \sqrt{{x}_{2}^{2} + {y}_{2}^{2}} - {( k λ + {Δ}_{2} )}^{2} ) \\ {C}_{9} = {β}_{2} {x}_{2}^{2} - {α}_{2} {y}_{2}^{2} \\ {C}_{10} = {β}_{2} {x}_{2}^{3} + {β}_{2} {x}_{2} {y}_{2}^{2}\end{matrix}$$

C₁₁=x₂y₂(β₂−α₂)

$$\begin{matrix}{C}_{12} = {β}_{2} {y}_{2}^{3} + {β}_{2} {y}_{2} {x}_{2}^{2} \\ {C}_{13} = {β}_{2} {y}_{2}^{2} - {α}_{2} {x}_{2}^{2}\end{matrix}$$

C₁₄=β₂(α₂−C₈)

The extension of this technique to the 3-dimensional case is straightforward.

What I claim as my invention is:

1. A method and apparatus for measuring the physical location of a source of radiated electromagnetic energy comprising:
several means for receiving said radiated electromagnetic energy, one of which will be referred to as the reference signal;
a means for measuring the phase of each of said received electromagnetic energy with respect to said reference signal; and,
a process for computing the position of the transmitter in which said phase differences are used to calculate the physical position of the transmitter.

2. A method and apparatus for measuring the physical location of a source of radiated electromagnetic energy comprising:
several means for receiving said radiated electromagnetic energy, one of which will be referred to as the reference signal;
several spatially separated means for amplifying said received electromagnetic energy;
several means for comparing the phase of said amplified received electromagnetic energy with respect to said reference signal; and,
a process for computing the position of the transmitter in which said phase differences are used to calculate the position of the transmitter.

3. A method and apparatus as in claim 2 in which the receiving means is a radio frequency antenna.

4. A method and apparatus as in claim 2 in which the means for amplifying said received electromagnetic energy includes a narrow bandpass filter.

5. A method and apparatus as in claim 2 in which said transmitter's position is known at the beginning or at the end of the measurements.

6. A method and apparatus as in claim 2 in which said electromagnetic energy receiving means are connected to the phase measuring means by any phase preserving means.

7. A method and apparatus as in claim 2 in which the means for amplifying said received electromagnetic energy includes spatial separation of said amplifiers.

8. A method and apparatus for determining the position of a movable object relative to a radiating source whose position is known by a process which is the inverse of that of claim 1. That is, the multiplicity of receiving antennas are spatially distributed on the movable body and a received signal from a known location is used to determine the movable body's position relative to the transmitter whose position is known.

9. A method and apparatus as in claim 8 in which a multiplicity of sources of radiated energy from sources whose positions are known are used to determine the position and orientation of the movable object.

10. A method and apparatus as in claim 1 in which multiple sources of radiated energy are used to determine the position and orientation of the movable object relative to a known set of receiving antennas.

11. A method and apparatus as in claim 10 in which a multiplicity of sources of radiated energy from sources whose positions are known are used to determine the position and orientation of the movable object.
